(19) United States
(12) Patent Application Publication
(10) Pub. No.: US 2010/0296554 A1
(43) Pub. Date: Nov. 25, 2010

(54) METHOD AND SYSTEM FOR DETECTING DATA FROM MULTIPLE ANTENNAS

(75) Inventors: Kiran ULN, Pleasonton, CA (US); Chih Liang CHANG, Jhubei (TW); Chien-Cheng TUNG, Fremont, CA (US)

Correspondence Address: Sawyer Law Group, P.C., P.O. Box 51418, Palo Alto, CA, 94303, US

(73) Assignee: RALINK TECHNOLOGY (SINGAPORE) CORPORATION, Singapore (SG)

(21) Appl. No.: 12/468,835

(22) Filed: May 19, 2009

(51) Int. Cl. H04B 1/38; H04L 27/22

(52) U.S. Cl. 375/219; 375/322

(57) ABSTRACT

Varying embodiments of the present invention provide a MIMO apparatus, such as a transceiver and a method of operation thereof. In an embodiment, the transceiver employs a parallelized, two-stage pipeline architecture that reduces the overall latency of the system. This reduction in latency translates to cost savings and higher data rates for the same hardware clock speed.

### FIELD OF THE INVENTION

The present invention relates generally to communication systems and more particularly to wireless communication systems.

### BACKGROUND OF THE INVENTION

Personal devices, such as computers, phones, personal digital assistants and the like have gained wide popularity in recent years. As technology improves, these devices have become increasingly smaller in size and highly portable. In fact, wireless, portable devices of various types now commonly communicate with one another allowing users flexibility of use and facilitating data, voice and audio communication. To this end, networking of mobile or portable and wireless devices is required.

With regard to the wireless networking of personal devices, a particular modem, namely modems adapted to the up-coming IEEE 802.11n industry standard, are anticipated to be commonly employed. This standard allows for an array of antennas to be placed inside or nearby the personal device and a radio frequency (RF) semiconductor device receives signal or data through the array and an analog-to-digital converter, typically located within the personal device, converts the received signal to baseband range. Thereafter, a baseband processor is employed to process and decode the received signal to the point of extracting raw data, which may be files transferred remotely and wireless, from another personal device or similar equipment with the use of a transmitter within the transmitting PC.

To do so, pointing of the array of antennas, which is essentially multiple antennas, hence the name multi-input-multi-output (MIMO), to the desired location to maximize reception and transmission quality is an issue. For example, data or information rate throughput, signal reception and link range are improved. The latest IEEE802.11n standard currently being developed includes advanced multi-antenna techniques in order to process parallel data streams simultaneously in order to increase throughput capability, and improve link quality by “smartly” transmitting and receiving the RF signals.

MIMO has drawn attention as the technique for enabling a high-capacity (high-speed) data communication by effectively using a frequency band. The MIMO is the technique to transmit separate data streams from a plurality of antennas of a transmitter by using a plurality of antennas in both of the transmission and the reception, that is to say, by using the transmitter having a plurality of antennas and the receiver having a plurality of antennas, and individually separate a plurality of transmission signals (data streams) mixed on a transmission path from the signal received by each receiving antenna of the receiver by using a transmission path (channel) estimate value, thereby improving a transmission rate without requiring an enlargement of the frequency band.

FIG. 1 shows the general structure of a typical MIMO OFDM system according to the prior art. The MIMO transmitter 100 has multiple antennas 110A-110C each capable of transmitting independent signals to a MIMO receiver 120 which is also equipped with multiple receive antennas 130A-130B. The transmitter 100 may comprise a forward error correction (FEC) code encoder 101, an interleaver 102, a MIMO constellation Mapper 103, an OFDM MIMO IFFT 104 and an analog and RF unit 105. The MIMO receiver 120 may comprise an RF and analog unit 121, a MIMO FFT 122, a MIMO demodulator 123 (like a slicer), a de-interleaver 124 and a FEC Decoder 125, all of which are used to convert the incoming RF signals into spatial streams representing bits of information sent over the channel. The MIMO demodulator receives a plurality of spatial streams of bits, and converts them into information in a format required by the FEC decoder. In some MIMO systems the demodulator performs hard decision and delivers information bits whereas in other systems the decoder delivers soft output for further soft decoding to be performed in a Viterbi decoder, low density parity check (LDPC) decoder or the like. Here the demodulator 123 is a maximum likelihood (ML) demodulator that might employ a Fixed Sphere Demodulator algorithm.

The ML demodulator for a MIMO receiver operates by comparing the received signal vector with all possible noiseless received signals corresponding to all possible transmitted signals. Under certain assumptions, this receiver achieves optimal performance in the sense of maximizing the probability of correct data detection. The main idea behind the Fixed Sphere Demodulator is to perform a search over only a fixed number of possible transmitted signals, generated by a small subset of all possible signals located around the received signal vector. This ensures that the demodulator complexity is not only reduced, but also fixed over time—a major advantage for hardware implementation. In order for such a search to operate efficiently, a key point is to order the antennas in such a way that most of the points considered relate to transmit antennas with the poorest signal-to-noise (SNR) conditions. Antennas with higher SNR conditions are much more likely to be detected correctly, based only on the received signal.

The ML demodulator has exponential complexity in the number of spatial streams being received. However using suitable ordering and subset choice, the implementation of Fixed Sphere Demodulator can be made essentially linear complexity.

### SUMMARY OF THE INVENTION

Varying embodiments of the present invention provide a MIMO apparatus, such as a transceiver and a method of operation thereof. In an embodiment, the transceiver employs a parallelized, two-stage pipeline architecture that reduces the overall latency of the system. This reduction in latency translates to cost savings and higher data rates for the same hardware clock speed.

A first embodiment of the present invention is a method of operating a multiple input multiple output (MIMO) demodulator comprising receiving a plurality of spatial streams wherein the plurality of spatial streams comprise in-phase (I) and quadrature (Q) pairs of streams, calibrating the I and Q pairs of the plurality of streams, decomposing the calibrated I and Q pairs of the plurality of streams thereby creating a matrix wherein the matrix comprises an upper triangular and utilizing the matrix to perform a search sequence on the I and Q pairs of the plurality of streams in a parallel fashion.

A second embodiment of the present invention is a system for operating a MIMO demodulator, comprising means for receiving a plurality of spatial streams wherein the plurality of spatial streams comprise I and Q pairs of streams, means for calibrating the I and Q pairs of the plurality of streams, means for decomposing the calibrated I and Q pairs of the plurality of streams thereby creating a matrix wherein the matrix comprises an upper triangular and means for utilizing the matrix to perform a search sequence on the I and Q pairs of the plurality of streams in a parallel fashion.

A third embodiment of the present invention is A MIMO transceiver comprising a calibration module for receiving a plurality of spatial streams wherein the plurality of spatial streams comprise I and Q pairs of streams and calibrating the I and Q pairs of the plurality of streams, a decomposition module coupled to the calibration module for decomposing the calibrated I and Q pairs of the plurality of streams thereby creating a matrix wherein the matrix comprises an upper triangular, a sorting module for utilizing the matrix to perform a search sequence on the I and Q pairs of the plurality of streams in a parallel fashion.

Other aspects and advantages of the present invention will become apparent from the following detailed description, taken in conjunction with the accompanying drawings, illustrating by way of example the principles of the invention.

### BRIEF DESCRIPTION OF DRAWINGS

FIG. 1 shows the general structure of a typical MIMO OFDM system according to the prior art.

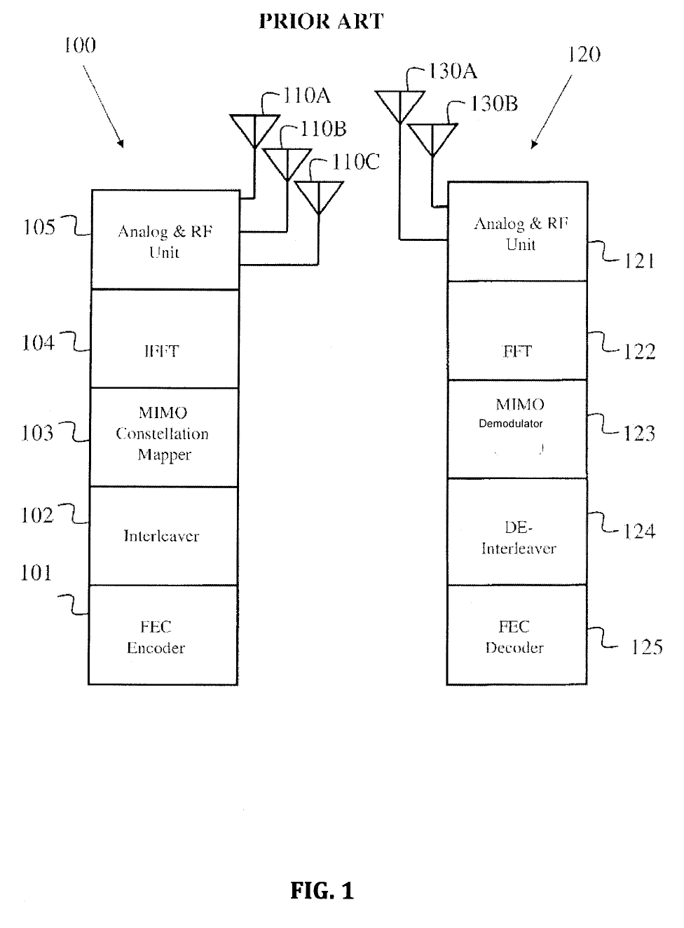

FIG. 2 illustrates a flowchart in accordance with an embodiment of the present invention.

FIG. 3 shows a simplified block diagram of a transceiver system in accordance with an embodiment of the present invention.

FIG. 4 shows a unitary matrix and an upper triangular matrix.

FIG. 5 shows a hypothetical subset S in 4 transmit antenna, 4 receive antenna system with 4-QAM constellations used at each transmit antenna.

### DETAILED DESCRIPTION OF PREFERRED EMBODIMENTS

The present invention relates generally to communication systems and more particularly to wireless communication systems. The following description is presented to enable one of ordinary skill in the art to make and use the invention and is provided in the context of a patent application and its requirements. Various modifications to the preferred embodiment and the generic principles and features described herein will be readily apparent to those skilled in the art. Thus, the present invention is not intended to be limited to the embodiment shown but is to be accorded the widest scope consistent with the principles and features described herein.

An embodiment of the present invention provides a MIMO apparatus, such as a transceiver and a method of operation thereof. In an embodiment, the transceiver employs a parallelized, two-stage pipeline architecture that reduces the overall latency of the system. The first stage is a projection calculation between the various streams and the second stage is a projection removal (and possible normalization). This reduction in latency translates to cost savings and higher data rates for the same hardware clock speed.

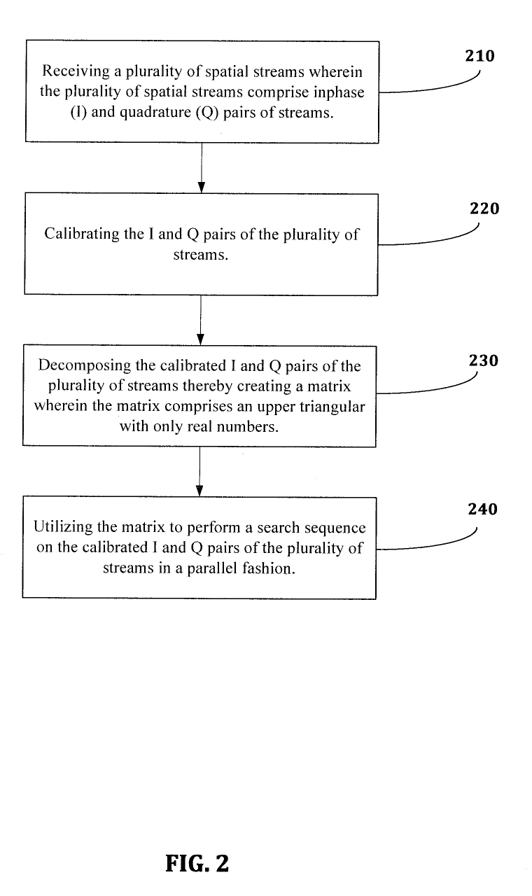

FIG. 2 illustrates a flowchart in accordance with an embodiment of the present invention. Step 210 involves receiving a plurality of spatial streams wherein the plurality of spatial streams comprise in-phase (I) and quadrature (Q) pairs of streams. A second step 220 involves calibrating the I and Q pairs of the plurality of streams. A third step 230 involves decomposing the calibrated I and Q pairs of the plurality of streams thereby creating a matrix wherein the matrix includes an upper triangular. A final step 240 includes utilizing the matrix to perform a search sequence on the calibrated I and Q pairs of the plurality of streams in a parallel fashion.

The implementation of the present invention is discussed in terms of “in-phase” and “quadrature-phase” spatial streams. The term in-phase is also found in the context of communication signals:

A(t)=I(t)cos(2πft+Φ(t)+Q(t)sin(2πft+Φ(t)))

where f and Φ(t) represents a carrier frequency and carrier phase, and A(t) represents the transmitted signal after modulation with a carrier wave, e.g.: cos(2πft+Φ(t)). The component that is in phase with the original carrier is referred to as the in-phase component. The other component, which is always 90° (π/2 radians) “out of phase”, is referred to as the quadrature component.

The system in accordance with the present invention can take the form of an entirely hardware implementation, an entirely software implementation, or an implementation containing both hardware and software elements. In one implementation, this detection procedure is implemented in software, which includes, but is not limited to, application software, firmware, resident software, microcode, etc.

Furthermore, the method can be implemented in the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W). To describe the features of the present invention in more detail, refer now to the following description in conjunction with the accompanying Figures.

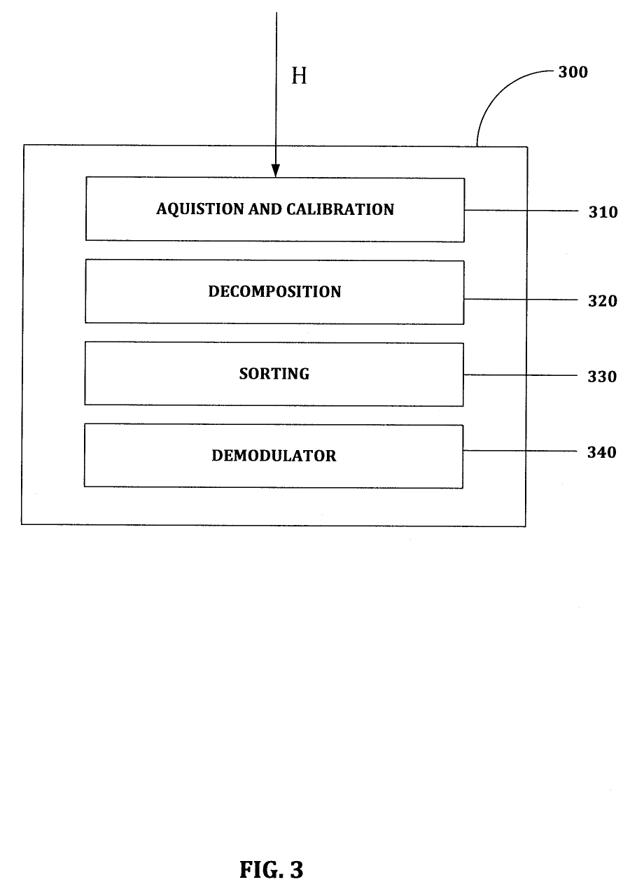

FIG. 3 shows a simplified block diagram of a transceiver system in accordance with an embodiment of the present invention. The transceiver system 300 includes four modules. The first module is the acquisition and calibration module 310 which performs a calibration of the received plurality of spatial streams H wherein the spatial streams H comprise I and Q pairs of streams. The second module is the decomposition module 320 which performs a decomposition of the calibrated I and Q pairs of the plurality of streams. The third module is a sorting module 330 which orders the received streams based on a metric. Thus, the sorting module 330 presents an order that requires the least complexity for the next block. The fourth module is a demodulator 340.

Calibration module 310 performs an I/Q calibration of the received plurality of spatial streams H. US Patent Application 20090046011 entitled “Method and Apparatus for Calibration for Beamforming of Multi-Input-Multi-Output Orthogonal Frequency Division Multiplexing (OFDM) Transceiver”, which is incorporated by reference in its entirety herein, discloses a calibration technique that could be utilized in conjunction with an embodiment in accordance with the present invention.

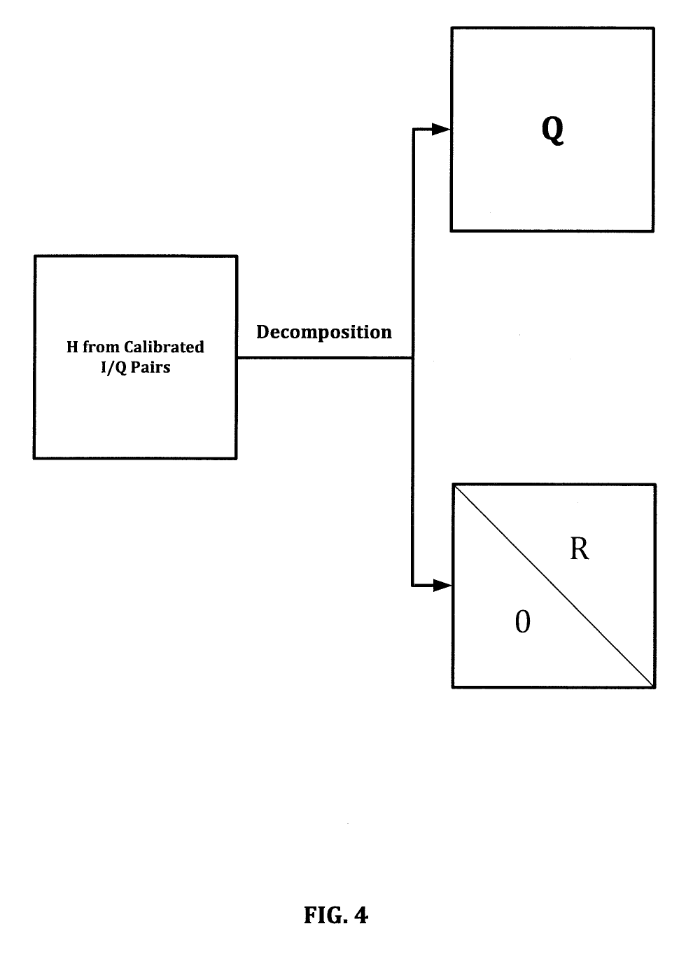

The output of the calibration module 310 is coupled to the decomposition module 320. Here, the calibrated I and Q pairs of the plurality of streams are decomposed thereby creating a matrix wherein the matrix comprises an upper triangular. A matrix decomposition is a factorization of a matrix into some canonical form. For instance, the QR decomposition expresses H as QR with Q a unitary matrix and R an upper triangular matrix. Accordingly, the system Hx=b (equivalently Q(Rx)=b) is solved by Rx=Q^{T}b=c, and the system Rx=c is solved by “back substitution”. An example of this can be seen in FIG. 4.

The output of decomposition module 320 is coupled to the input of the sorting module 330. Here, the matrix is utilized to perform a search sequence on the calibrated I and Q pairs of the plurality of streams whereby the search sequence is performed in a parallel fashion. As a result of the calibration step the Real (I) and Imaginary (Q) pairs are independent. Consequently, the FSD searches can be done in a parallel fashion. Because the FSD searches can be done in parallel, overall system latency is substantially reduced.

The search sequence can be conducted in a variety of ways. For example, a k-best algorithm or a pruning algorithm could be employed. The k-best algorithm is an algorithm to cluster n objects based on attributes into k partitions, k<n. It is similar to the expectation-maximization algorithm for mixtures of Gaussians in that they both attempt to find the centers of natural clusters in the data. It assumes that the object attributes form a vector space. The objective it tries to achieve is to minimize total intra-cluster metric, like, the squared error function

$$V = {\sum }_{i = 1}^{k} {\sum }_{{x}_{j} ∈ {S}_{i}} {( {x}_{j} - {μ}_{i} )}^{2}$$

where there are k clusters Sᵢ, i=1, 2, . . . , k, and μᵢ is the centroid or mean point of all the points xⱼ, Sᵢ. Different metrics like the l₁ norm can be used to reduce complexity in certain implementations.

With regard to the pruning algorithm, pruning is a term in mathematics and informatics which describes a method of enumeration, which allows parts of a decision tree to be cut. Pruned parts of the tree are no longer considered because the algorithm knows based on already collected data (e.g. through sampling) that these subtrees do not contain the searched object. The decision tree is simplified by removing some decisions. Decision trees are built with the available information and they are supporting tools in a decision making process. However, sometimes the given set of data may be irrelevant, erroneous or unnecessary, in which case the decision tree formed may not be correct; this phenomenon is called overfitting. Also, too much information may misguide the decision policy. When this happens, it becomes necessary to remove the nodes from the decision tree. The process of making the decision tree smaller by removing nodes that are not helpful is called pruning.

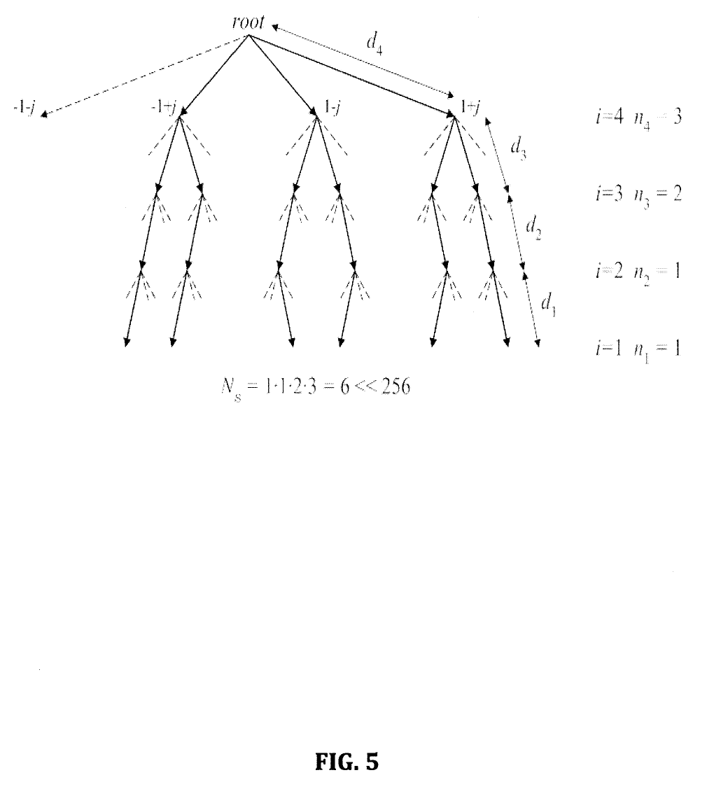

The result of this calibration, sorting and pruning reduces complexity. FIG. 5 shows a hypothetical 4 transmitter, 4 receiver MIMO system using 4-QAM for the four spatial streams. The original ML algorithm would require 4*4*4*4=256 searches. Because of the calibration, sorting and pruing, the new algorithm requires fewer points per level (i.e. sorted spatial stream) of (n1,n2,n3,n4)=(1,1,2,3). In each level, the nᵢ closest points to the received signal are considered as components of the subset S. In this case, the Euclidean distance of only 6 transmitted vectors would be calculated, whereas the total number of possible vectors, 256, is much larger.

Although the above-described algorithms are disclosed, one of ordinary skill in the art will readily recognize that a variety of different search algorithms could be employed while remaining within the spirit and scope of the present invention.

Varying embodiments of the present invention provide a MIMO apparatus, such as a transceiver and a method of operation thereof. In an embodiment, the transceiver employs a parallelized, two-stage pipeline architecture that reduces the overall latency of the system. This reduction in latency translates to cost savings and higher data rates for the same hardware clock speed.

Any publications, including patents, patent applications and articles, referenced or mentioned in this specification are herein incorporated in their entirety into the specification, to the same extent as if each individual publication was specifically and individually indicated to be incorporated herein. In addition, citation or identification of any reference in the description of some embodiments of the invention shall not be construed as an admission that such reference is available as prior art to the present invention.

Without further analysis, the foregoing so fully reveals the gist of the present inventive concepts that others can, by applying current knowledge, readily adapt it for various applications without omitting features that, from the standpoint of prior art, fairly constitute essential characteristics of the generic or specific aspects of this invention. Therefore, such applications should and are intended to be comprehended within the meaning and range of equivalents of the following claims. Although these inventive concepts have been described in terms of certain embodiments, other embodiments that are apparent to those of ordinary skill in the art are also within the scope of this invention, as defined in the claims that follow.

What is claimed is:

1. A method of operating a multiple input multiple output (MIMO) decoder comprising:
receiving a plurality of spatial streams wherein the plurality of spatial streams comprise inphase (I) and quadrature (Q) pairs of streams;
calibrating the I and Q pairs of the plurality of streams;
decomposing the calibrated I and Q pairs of the plurality of streams thereby creating a matrix wherein the matrix comprises an upper triangular; and
utilizing the matrix to perform a search sequence on the I and Q pairs of the plurality of streams in a parallel fashion.

2. The method of claim 1 wherein the search sequence comprises an exhaustive search.

3. The method of claim 1 wherein the search sequence comprises a smart search pattern.

4. The method of claim 3 wherein the smart search pattern comprises a pruned tree search pattern.

5. The method of claim 3 wherein the smart search pattern comprises a K-Best search pattern.

6. A system for operating a MIMO decoder, comprising:
means for receiving a plurality of spatial streams wherein the plurality of spatial streams comprise I and Q pairs of streams;
means for calibrating the I and Q pairs of the plurality of streams;
means for decomposing the calibrated I and Q pairs of the plurality of streams thereby creating a matrix wherein the matrix comprises an upper triangular; and
means for utilizing the matrix to perform a search sequence on the I and Q pairs of the plurality of streams in a parallel fashion.

7. The system of claim 6 wherein the search sequence comprises an exhaustive search.

8. The system of claim 6 wherein the search sequence comprises a smart search pattern.

9. The system of claim 8 wherein the smart search pattern comprises a pruned tree search pattern.

10. The system of claim 8 wherein the smart search pattern comprises a K-Best search pattern.

11. A MIMO transceiver comprising;
a calibration module for:
receiving a plurality of spatial streams wherein the plurality of spatial streams comprise I and Q pairs of streams, and;
calibrating the I and Q pairs of the plurality of streams;
a decomposition module coupled to the calibration module for decomposing the calibrated I and Q pairs of the plurality of streams thereby creating a matrix wherein the matrix comprises an upper triangular;
a sorting module for utilizing the matrix to perform a search sequence on the I and Q pairs of the plurality of streams in a parallel fashion.

12. The transceiver of claim 11 wherein the search sequence comprises an exhaustive search.

13. The transceiver of claim 11 wherein the search sequence comprises a smart search pattern.

14. The transceiver of claim 13 wherein the smart search pattern comprises a pruned tree search pattern.

15. The transceiver of claim 13 wherein the smart search pattern comprises a K-Best search pattern.
